(19) United States
(12) Patent Application Publication
(10) Pub. No.: US 2012/0167154 A1
(43) Pub. Date: Jun. 28, 2012

(54) SYSTEM AND METHOD FOR PROVIDING SOCIAL NETWORK SERVICE TO MULTIPLE SCREEN DEVICES

(75) Inventors: Ji-Woon KIM, Seoul (KR); Sang-Mok PARK, Suwon-si (KR)

(73) Assignee: KT CORPORATION, Seongnam (KR)

(21) Appl. No.: 13/333,504

(22) Filed: Dec. 21, 2011

(30) Foreign Application Priority Data
Dec. 24, 2010 (KR) 10-2010-0134275

(51) Int. Cl. H04N 21/60

(52) U.S. Cl. 725/109

(57) ABSTRACT

A system for providing a social network service to multiple screen devices is disclosed. The system includes an integrated address book generating unit configured to generate an integrated address book based on contact information stored in at least one of the multiple screen devices or contact information stored in an accessible server, a personal page providing unit configured to provide a personal page to at least one of the multiple screen devices, a message managing unit configured to display a message, which has been transmitted from at least one of the multiple screen devices, on other screen devices of the multiple screen devices, and a personal content managing unit configured to display content, which has been uploaded from at least one of the multiple screen devices, on other screen devices of the multiple screen devices.

### CROSS-REFERENCE TO RELATED PATENT APPLICATION

This application claims priority from Korean Patent Application No. 10-2010-0134275, filed on Dec. 24, 2010 in the Korean Intellectual Property Office, the entire disclosure of which are incorporated herein by reference.

### BACKGROUND

1. Field

The present disclosure relates to a system and a method for providing a social network service implemented in multiple screen devices.

More specifically, the present disclosure relates to a system and a method for providing a social network service to multiple devices, which carry out communication in different manners and have screens in different sizes, such as a web access terminal, an Internet Protocol Television (IPTV), and a smart phone, by sharing an address book, a channel talk, content, or messages.

2. Description of the Related Art

As wired or wireless network technology has advanced, various business models capable of providing communities and exchanging content or messages between users have been developed. With the recent development of wireless network technology, the community business models have extended from a web-based community service to a mobile-based community service.

The community service provides on-line spaces, in which users can communicate with each other, and furthermore, the community service provides a social network service (SNS), which establishes a social network by associating users with one another and provides a wide variety of information and interesting issues through the social network.

However, since the community service and the social network service have been provided through the Internet service, there has been a difficulty in applying the community service and the social network service to a content broadcasting system such as an IPTV. An IPTV provides a user with various real-time broadcasting content or video on demand (VOD) via a private line, and high-definition content suitable for a large TV screen. Accordingly, a user may feel greater satisfaction from the content of an IPTV when compared to a user of the web service or the mobile service.

However, the IPTV generally uses a closed network and a remote controller designed only for content viewing as an input device. Thus, it has been difficult to extend the existing community service or the social network service to the IPTV.

Accordingly, there have been no sufficient means for enabling social network members to share their opinions and information with regard to content such as real-time broadcasting content.

### SUMMARY

In order to address the above-described conventional problems, the exemplary embodiments provide a social network service to multiple screen devices including an IPTV.

According to an aspect of an exemplary embodiment, provided is a system for providing a social network service to multiple screen devices. The system includes an integrated address book generating unit configured to generate an integrated address book based on contact information stored in at least one of the multiple screen devices or contact information stored in an accessible server, a personal page providing unit configured to provide a personal page to at least one of the multiple screen devices, a message managing unit configured to display a message, which has been transmitted from at least one of the multiple screen devices, on other screen devices of the multiple screen devices, and a personal content managing unit configured to display content, which has been uploaded from at least one of the multiple screen devices, on other screen devices of the multiple screen devices. Here, the multiple screen devices include an Internet Protocol Television (IPTV), and the social network service is provided based on information included in the integrated address book.

In an aspect of an exemplary embodiment, the system may further include a channel information managing unit configured to provide the multiple screen devices with real-time information on broadcast content for each channel and to receive a review of each of the broadcast content from the multiple screen devices.

In an aspect of an exemplary embodiment, the review of the content may be overlaid on the content displayed on a screen of the IPTV.

In an aspect of an exemplary embodiment, the system may further include an application providing unit configured to provide an application for generating the integrated address book in a smart phone included in the multiple screen devices.

In an aspect of an exemplary embodiment, the application providing unit may be further configured to provide an application for providing the real-time information on broadcast content to the smart phone.

In an aspect of an exemplary embodiment, the system may further include a data converting unit configured to convert data of the message or the content to be suitable for a resolution of each of the multiple screen devices.

According to an aspect of another exemplary embodiment, provided is a method for providing a channel talk service to multiple screen devices including an Internet Protocol Television (IPTV). The method includes (a) providing real-time information on broadcast content for each channel of the IPTV to other screen devices of the multiple screen devices, (b) receiving a message associated with the broadcast content from one of the multiple screen devices and (c) transmitting the received message to the multiple screen devices. Here, the received message is overlaid on the broadcast content displayed on a screen of the IPTV.

In an aspect of another exemplary embodiment, the multiple screen devices may include a smart phone, and the information on broadcast content may be provided through an application of the smart phone.

In an aspect of another exemplary embodiment, the IPTV may be configured to activate a menu for displaying the message in response to input from a remote controller of the IPTV.

According to an aspect of another exemplary embodiment, provided is a method for providing a social network service to multiple screen devices. The method includes receiving data from one of the multiple screen devices, converting the data to be suitable for each of the multiple screen devices, notifying the multiple screen devices of the receipt of the data and transmitting the converted data to each of the multiple screen devices. Here the multiple screen devices include an Internet Protocol Television (IPTV), and when the IPTV is activated, the notification of the receipt of the data is displayed on a screen of the IPTV.

In an aspect of another exemplary embodiment, the method may further include generating an integrated address book, which can be used by all the multiple screen devices. Here, the notification of the receipt of the data may be sent with reference to the integrated address book.

In an aspect of another exemplary embodiment, the integrated address book may be generated based on contact information stored in at least one of the multiple screen devices or contact information stored in an accessible server.

In an aspect of another exemplary embodiment, the data may include a message transmitted to other device from one of the multiple screen devices and content uploaded onto a personal page of a user of the multiple screen devices.

In an aspect of another exemplary embodiment, the message may be transmitted to the other device with reference to the integrated address book.

In an aspect of another exemplary embodiment, the notification of the receipt of the content may be sent to at least one device stored in the integrated address book.

According to the above-described aspects of the exemplary embodiments, IPTV users can easily establish communities through the integrated address book and receive the social network service through interworking of the web and smart phones.

Furthermore, even if devices, which can be used by a plurality of users, are different, the users can still enjoy message exchanges, content uploads, and other services by using their preferred devices.

### BRIEF DESCRIPTION OF THE DRAWINGS

Non-limiting and non-exhaustive exemplary embodiments will be described in conjunction with the accompanying drawings. Understanding that these drawings depict only several exemplary embodiments in accordance with the disclosure and are, therefore, not intended to limit its scope, the disclosure will be described with specificity and detail through use of the accompanying drawings, in which:

FIG. 1 is a view generally showing a plurality of social network services according to an exemplary embodiment;

FIG. 2 is a view showing a method for generating an integrated address book according to an exemplary embodiment;

FIG. 3 is a block diagram showing a social network service providing system according to an exemplary embodiment;

FIG. 4 is a flow chart showing a method for providing a channel talk according to an exemplary embodiment;

FIG. 5 is a flow chart showing a method for sharing messages and content among three screen devices according to an exemplary embodiment;

FIG. 6 is a reference view illustrating a channel talk for a smart phone according to an exemplary embodiment;

FIG. 7 is a reference view illustrating a channel talk for a web service according to an exemplary embodiment;

FIG. 8 is a reference view for illustrating a channel talk for an IPTV according to an exemplary embodiment;

FIG. 9 is a reference view showing an identification of a message on an IPTV according to an exemplary embodiment;

FIG. 10 is a reference view showing a screen displaying a message exchange on a smart phone according to an exemplary embodiment; and

FIG. 11 is a reference view showing a screen displaying a message exchange on a web page according to an exemplary embodiment.

### DETAILED DESCRIPTION OF EXEMPLARY EMBODIMENTS

Hereinafter, exemplary embodiments will be described in detail with reference to the accompanying drawings so that the inventive concept may be readily implemented by those skilled in the art. However, it is to be noted that the present disclosure is not limited to the exemplary embodiments but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. Further, the term “comprises or includes” and/or “comprising or including” used in the document means that one or more other components, steps, operations, and/or the existence or addition of elements are not excluded in addition to the described components, steps, operations and/or elements.

Hereinafter, exemplary embodiments will be explained in detail by reference to the accompanying drawings.

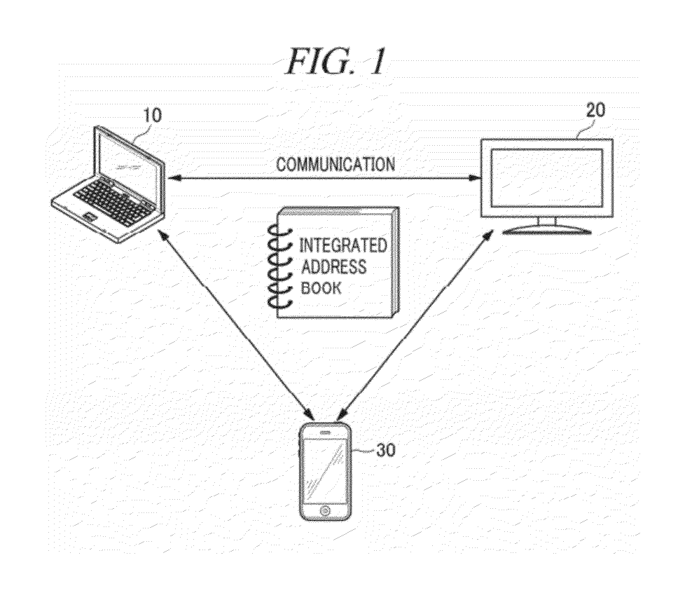

FIG. 1 is a view generally showing a plurality of social network services according to an exemplary embodiment.

A social network service providing system according to an exemplary embodiment may include a PC 10 capable of accessing a web, an internet protocol television (IPTV) 20 capable of receiving real-time channel broadcasting or videos on demand (VODs), and a smart phone 30.

Meanwhile, the PC 10 in the exemplary embodiment may be substituted with any terminal capable of accessing a specific web page through a web browser to use content thereon.

The IPTV 20 in the exemplary embodiment may be substituted with any bi-directional broadcasting terminals capable of receiving real-time broadcasting or VODs to transmit the real-time broadcasting or the VODs through display devices, and transmitting data from a user to servers.

The smart phone 30 is a terminal having a wireless communication function, and may be substituted with any mobile terminals capable of carrying out data communication for a social network service.

Although the PC 10, the IPTV 20, and the smart phone 30 may have different screen sizes or resolution, they all have screens for displaying data. Accordingly, in this specification, each of the PC 10, the IPTV 20, and the smart phone 30 is referred to as the “screen device.”

“N screen devices” mean that the number of the screen devices is N. “N screen services” means properly providing identical or similar content or services to each of N screen devices.

One user may use all the PC 10, the IPTV 20, and the smart phone 30, which are illustrated. It is assumed that the user has subscribed to all three screen device services.

Here, an integrated address book may be generated in order to exchange information and opinions with other users by using one of the three screen devices.

The integrated address book may be generated by integrating address books managed by the three screen devices and converting them to be in a state so that the single integrated address book can be used in a dedicated service for each of the screen devices.

The integrated address book may be generated and updated as set forth below:

(1) Generated from a contact address book of a smart phone

(2) Generated from a web address book stored in a specific server

(3) Generated by a friend registration request sent to a user from another user, or a friend registration request from the user to another user

That is, the integrated address book can be generated by using friend information used in the service of each of the screen devices such that the integrated address book can be used in all the three screen devices for the social network service.

The integrated address book is especially useful for the IPTV 20 screen device, in which generating or inputting friend information is difficult.

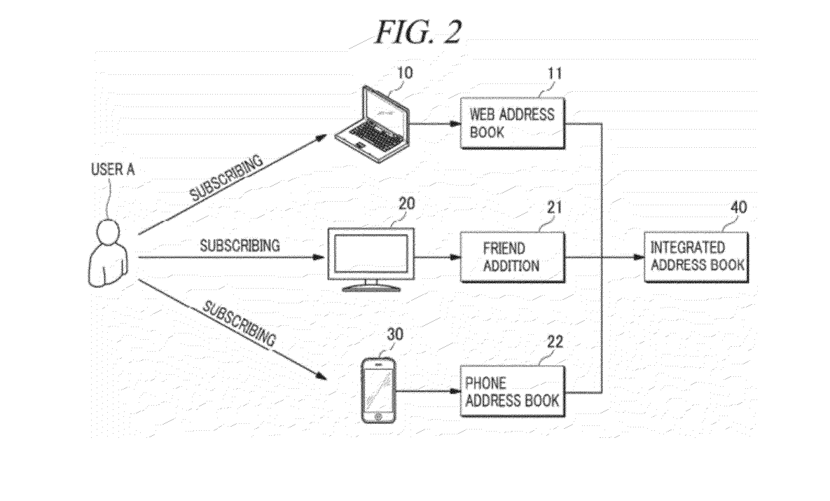

FIG. 2 is a view showing a method for generating an integrated address book according to an exemplary embodiment.

A user A subscribes to each of the screen device services through the PC 10, the IPTV 20, and the smart phone 30, and also subscribes to the three screen device services through interworking of accounts of the screen device services.

Here, the account of the web service using the PC 10 may be log-in ID or an e-mail account. The account of the IPTV 20 may be a device ID or a personal ID. A plurality of personal IDs may be assigned to one IPTV 20.

The account of the smart phone 30 may be a personal ID or a phone number.

The accounts of the screen devices interwork such that one of the screen devices synthesizes a result of transmitting and receiving generated messages or content with the other screen devices.

Meanwhile, the user A may use an address book 11 provided by a server of a specific site such as a portal site by using the PC 10. The user A may manage contact information of friends at a place where web access is possible, through the web address 11. The social network service system according to an exemplary embodiment may generate or update the integrated address book by using the web address book 11. In general, the web address book 11 can be downloaded in the form of a file or the like. Thus, the social network service system may generate or update the integrated address book by modifying the web address book 11 to be in compliance with the integrated address book format.

The user A may visit a personal page provided by the IPTV 20, and add a new user as a friend through a friend request 21. In this case, the user who is added as a new friend is updated as a friend in the integrated address book of the user A.

The user A may generate or update the integrated address book by using a phone address book 22 stored in the smart phone 30. The phone address book 22 may be implemented to be included in the integrated address book 40 by an application implemented as an application programming interface (API) supported by an operating system of each smart phone.

The integrated address book 40 generated in this manner is treated to interwork in all three screen device services in a social network providing system, which will be described later.

Accordingly, if a friend recorded in the phone address book 22 is a subscriber of the IPTV 20, the user A may use the social network service in the service of the IPTV 20, without separately making a friend request 21 on the IPTV.

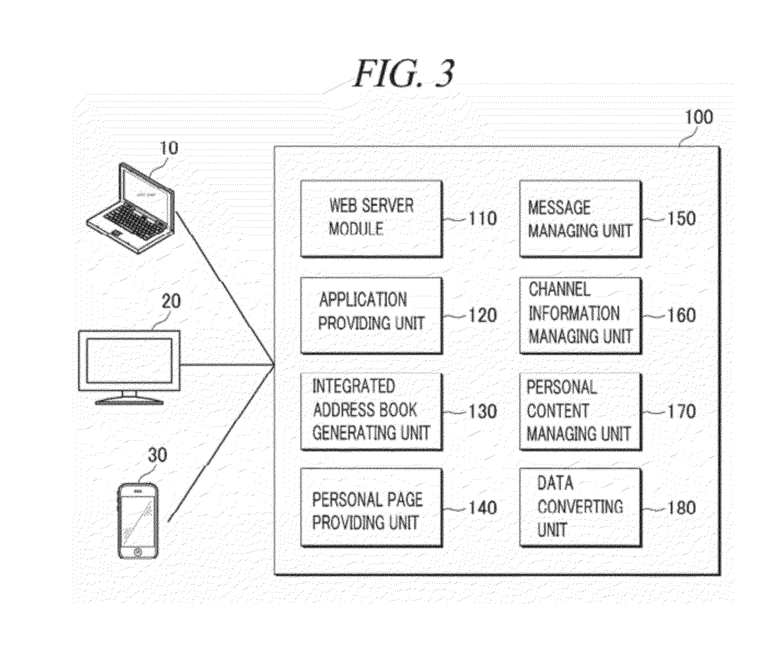

FIG. 3 is a block diagram showing configuration of a social network service providing system according to an exemplary embodiment.

A social network service providing system 100 according to an exemplary embodiment includes a web server module 110, an application providing unit 120, an integrated address book generating unit 130, a personal page providing unit 140, a message managing unit 150, a channel information managing unit 160, a personal content managing unit 170, and a data converting unit 180.

The web server module 110 provides a web page, which can be accessed through the PC 10 capable of using the web service, among the screen devices. The web server module 110 may provide a channel talk page, on which content review comments are immediately recorded through the web, a message display page, on which a message exchange on the smart phone and the IPTV, as well as chatting through the web, are synthesized, a personal page, on which a user uploads images or videos and invites other users' visit to the page, and others.

The application providing unit 120 provides an application, which enables a user of the smart phone to share an address book, messages, and content with the other screen devices by using the smart phone. The application providing unit 120 may also implement on an app store operated by each smart phone operating system. By using the application, the user may incorporate a phone and address book into the integrated address book or input comments with regard to content broadcasts on the IPTV. Furthermore, the application providing unit 120 may provide an application for recording or displaying review comments with regard to content that is broadcast on the IPTV in real time.

The integrated address book generating unit 130 generates the integrated address book, which can be used by a user in the multiple screen devices, by using records of the web address book, the phone address book, the friend request and acceptance 21, and others. The generated integrated address book may be updated in accordance with the latest records of the web address book, the phone address book, and the friend request acceptance 21.

The personal page providing unit 140 provides a personal page, on which a user uploads messages or content to allow other users to visit the page. The personal page may be provided to a user in various forms such as a community, a cafe, and a blog. A user may access a personal page through a web browser, the IPTV, and the smart phone.

The message managing unit 150 manages messages exchanged among the three screen devices. Since the three screen devices share the integrated address book, message exchange by one screen device may be synthesized with and displayed on the other screen devices. For example, an SMS message, which has been exchanged through the smart phone, may be presented as an interface such as chatting or a messenger on the web service or the IPTV.

The channel information managing unit 160 displays content information of a real-time broadcasting channel of the IPTV on the web page or a document, which can be accessed by the smart phone, in real time. In accordance with the real-time information of the broadcasting channel, a user may exchange content review opinions in real time while viewing content on the IPTV. In this specification, the service enabling exchange of content review opinions is referred to as “channel talk.” Through the channel talk, a user can record content review comments by using any of the three screen devices, and read other users' review comments.

The personal content managing unit 170 stores and manages content uploaded by a user onto the personal page. The content may be images or videos. Personal content uploaded through one screen device are also synthesized and registered on the personal pages of the other screen devices. The personal content managing unit 170 encodes the content in a format suitable for storage and posting. Furthermore, the personal content managing unit 170 manages content updates, content review ratings, content recommendation ratings, and the like to provide related information to a user. For example, when a new content is updated, the personal content managing unit 170 may notify the user's friends of the updated status by using the integrated address book.

The data converting unit 180 converts a message generated in one of the three screen devices, content, and changes in the personal pages to be in the format that can be displayed on the other screen devices. For example, the data converting unit 180 converts the personal page generated on the web into the personal page on the IPTV.

The elements of the social network service providing system that have been described are not implemented individually, but can be implemented together with at least one logical and physical element. Furthermore, the elements of the social network service providing system may be implemented in the manner that the elements are dispersed throughout a plurality of hardware elements.

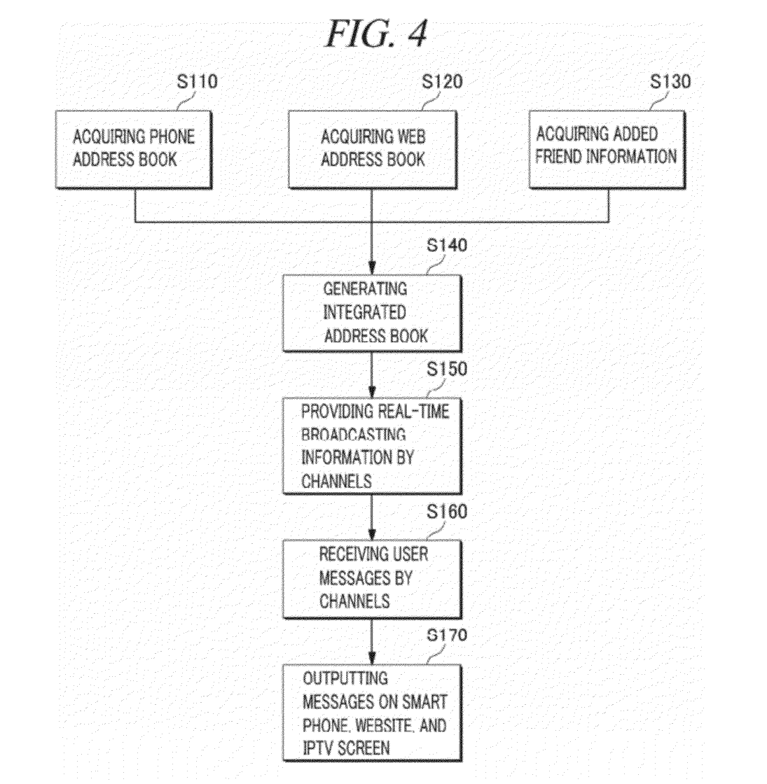

FIG. 4 is a flow chart showing a method for providing a channel talk according to an exemplary embodiment.

In operation S110, operation S120, and operation S130, the phone address book, the web address book, and the added friend information are acquired from the three screen devices.

In operation S140, the integrated address book is generated by using the acquired information. The integrated address book can be used by all the three screen devices, and are especially useful for the IPTV, in which inputting and generating friend information is difficult.

In operation S150, real-time broadcasting information of each channel is provided through the three screen devices. In case of the IPTV, real-time broadcasting content is directly transmitted. However, in case of the PC or the smart phone, broadcasting content does not need to be directly transmitted. For example, it is sufficient to present only titles of content, which is being broadcast on each broadcasting channel.

A user selects one of the IPTV, the PC, and the smart phone to input review message while viewing the content. Then, the social network service providing system receives the message, and outputs the message on the screens of the three screen devices (operation S160 and operation S170).

Through the aforementioned “channel talk” service, a user can input a review message by selecting and using a preferred input device. Together with viewing the content, the user can identify other users' review messages and share opinions with other users, so that the user can enjoy viewing the content.

Conventionally, real-time content review messages could have been identified only on a specific web site or a chatting window of a video player. However, according to an exemplary embodiment, the three screen devices share content review messages, and in particular, the IPTV is advantageous in that a user can read other users' review messages while viewing the content.

According to an exemplary embodiment, advantages of devices having excellent portability such as the smart phone and devices having excellent content replaying quality are utilized, so that it is possible to provide a user with services having high convenience, compared to conventional chatting or message board services.

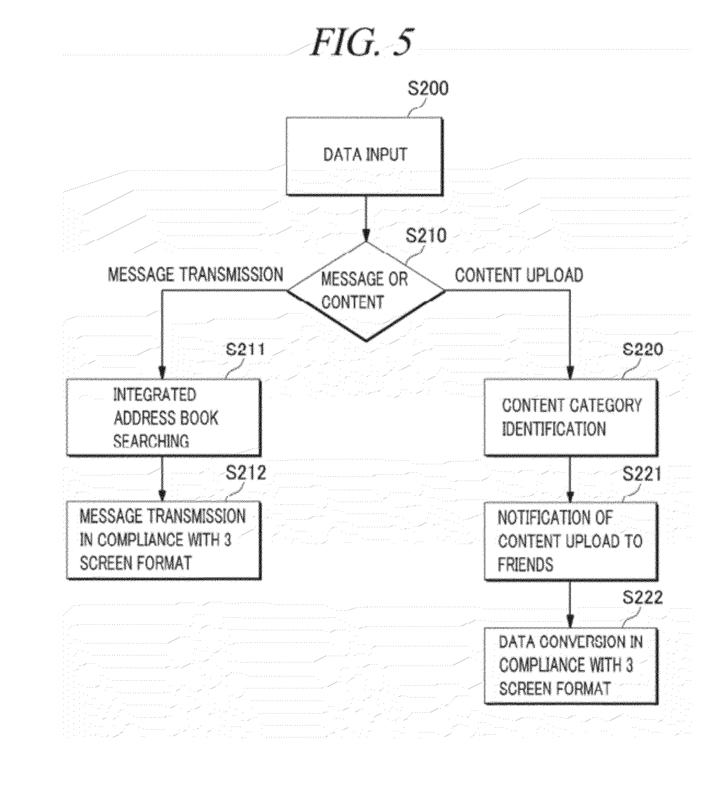

FIG. 5 is a flow chart showing a method for sharing messages and content among three screen devices according to an exemplary embodiment.

Prior to sharing messages and content, generating the integrated address book in operation S110, operation S120, operation S130, and operation S140 illustrated in FIG. 4 should be carried out.

In operation S200, a user inputs data by using the screen device, which is one of the PC, the smart phone, and the IPTV. The data may be messages or content. In operation S210, the messages are transmitted, or the content is uploaded.

The transmission of the messages may be carried out using SMS, a messenger, and/or chatting. In the case of the smart phone, the message transmission may be carried out in the manner of transmitting an SMS to a phone number of a friend in the integrated address book. In case of the IPTV, the message transmission may be carried out in the form of reply comments to specific user's messages or posts such as the aforementioned channel talk.

Regardless of which screen device is used for the message transmission, if the message transmission is carried out using the integrated address book, all the three screen devices can display the message exchange (operation S211).

In operation 5212, a message input through one screen device is converted to be in compliance with the three screen formats and then transmitted. For example, a message input in the form of an SMS in the smart phone is converted into the form of chatting in the web service and the IPTV, and can be displayed on both of the screens.

Meanwhile, if the input data are not messages to be transmitted to a specific user, and is personal content, content categories are first identified (operation S220). Content categories may be texts, images, videos, and others, and may be input directly by a user, or automatically identified through file formatting upon uploading.

Once a new content is uploaded, a friend of the user may be notified of the content upload to (operation S221). The notification of the new content upload is a message including a link to the content, and may be transmitted to the smart phone, the PC, and the IPTV in the form of an SMS, a note, an e-mail, and/or a pop-up. Especially, in the case of the IPTV, when the IPTV is activated such that the IPTV is broadcasting content, the notification may be overlaid and displayed on the screen for the broadcasting.

A content uploaded through one screen device is converted by the data converting unit to be in compliance with the three screen format (operation S222). For example, writings written on the web page may be posted on a dedicated page for the smart phone in compliance with a template suitable for the screen size of the smart phone. The uploaded content may be encoded in compliance with a bandwidth and resolution provided by each of the screen devices. For example, since the IPTV is capable of providing a broadband service through a private line, encoding with high resolution is possible. However, in case of content for the web service, encoding may be carried out in the format having a higher compression ratio than that for the IPTV and low resolution.

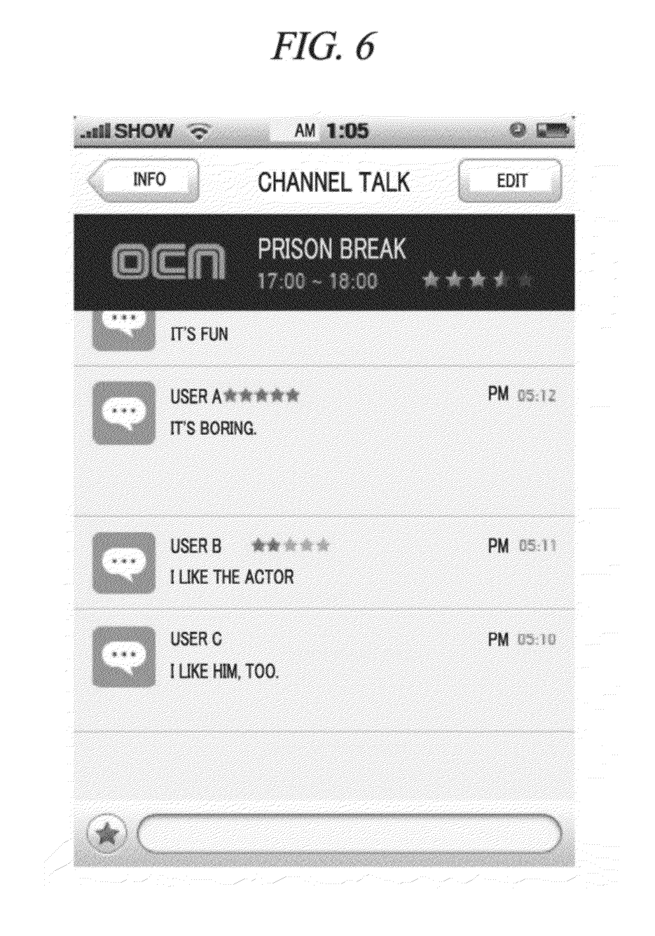

FIG. 6 is a reference view for explanation of a channel talk for a smart phone according to an exemplary embodiment.

As illustrated in FIG. 6, with regard to a specific content, which is being subject to broadcasting, a user may write review opinions in the reply comment form by using the smart phone. An interface for the channel talk may be provided through an application provided in the social network service providing system or a specific app store.

A user logs in through the application, and then identifies a list of content, which are being subject to broadcasting on each channel. Thereafter, the user selects content to read other users' review comments or write a review opinion in the reply comment form.

By using this function, the user can exchange opinions regarding content with other users through the smart phones that they are carrying, while viewing the content on the IPTV.

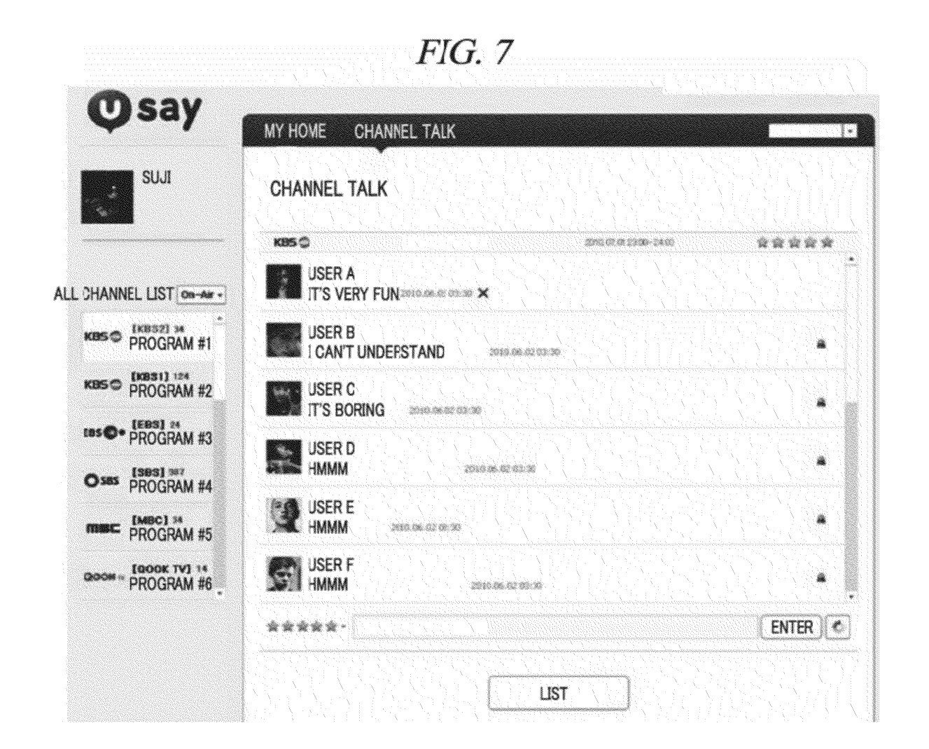

FIG. 7 is a reference view for explanation of a channel talk for a web service according to an exemplary embodiment.

As illustrated in FIG. 7, the user may access a specific web page and write a review opinion regarding a specific content, which is being subject to broadcasting, in the reply comment form. An interface for the channel talk is implemented on the web page. The user logs in and identifies a list of content, which are being subject to broadcasting on each channel. Thereafter, the user selects content to read other users' review comments or write a review opinion in the reply comment form, as illustrated in FIG. 7.

In the exemplary embodiment illustrated in FIG. 7, even in the case where review comments are written by using the smart phone, the review comments are synthesized and displayed on the web.

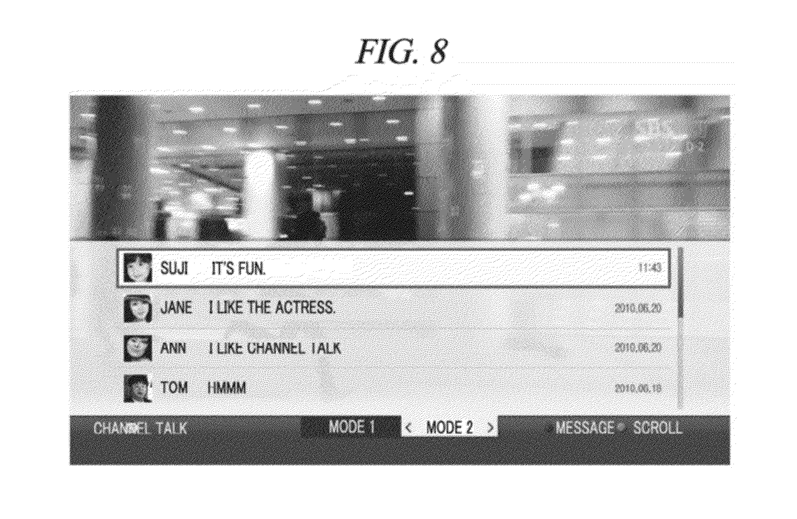

FIG. 8 is a reference view for explanation of a channel talk for an IPTV according to an exemplary embodiment.

As illustrated in FIG. 8, review comments regarding content are overlaid and provided on the content, so that the user can view the review comments regarding the content, which the user is viewing on a specific channel of the IPTV, together with the corresponding content. The review comments are text that another user inputs by using the channel talk service for the aforementioned smart phone and web service. The user activates the channel talk function by using a specific key on a remote controller while viewing content, to read related review comments.

The channel talk function includes a single line mode for exposing only the latest review comment and an extension mode for exposing a plurality of review comments through a scroll function.

Furthermore, the user can directly input review comments on the IPTV by using a message input key of a remote controller. In this case, it is also possible to identify review comments input in other screen devices such as the smart phone and the PC, as in the above-described exemplary embodiment.

As illustrated in FIGS. 6 to 8, users can share their opinions with regard to content, which is broadcast in real time, in the channel talk by using one of the multiple screen devices. Furthermore, even if a user inputs review comments through one of the multiple screen devices, he/she can identify the review comments input in the other screen devices. Accordingly, even if the user has a part of the three screen devices, he/she can freely use the above-described channel talk.

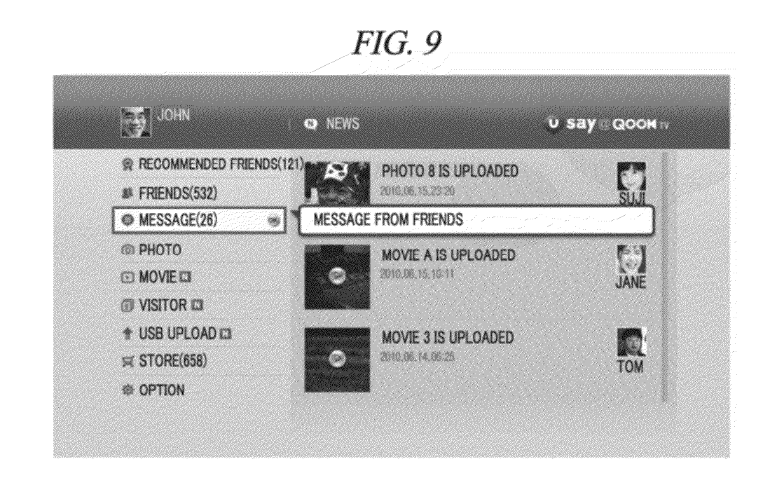

FIG. 9 is a reference view showing identification of a message on an IPTV according to an exemplary embodiment.

As illustrated in FIG. 9, an exemplary embodiment provides an IPTV viewer with a personal page. The personal page may be approached through an IPTV electronic program guide (EPG). The IPTV personal page may have a layout similar to the personal page for the web service, but may be partially converted to be in compliance with the format and the size suitable for the IPTV service.

The personal page provides a space, on which a user uploads content to post the content to other users, and furthermore, provides an update status of personal pages of friends included in the integrated address book. The update status of the personal pages of friends may be overlaid on content and provided in real time even during IPTV viewing, depending on settings.

As illustrated in FIG. 9, a user can identify exchanged message content by using the IPTV through a “message menu” or other screen devices (smart phone or PC).

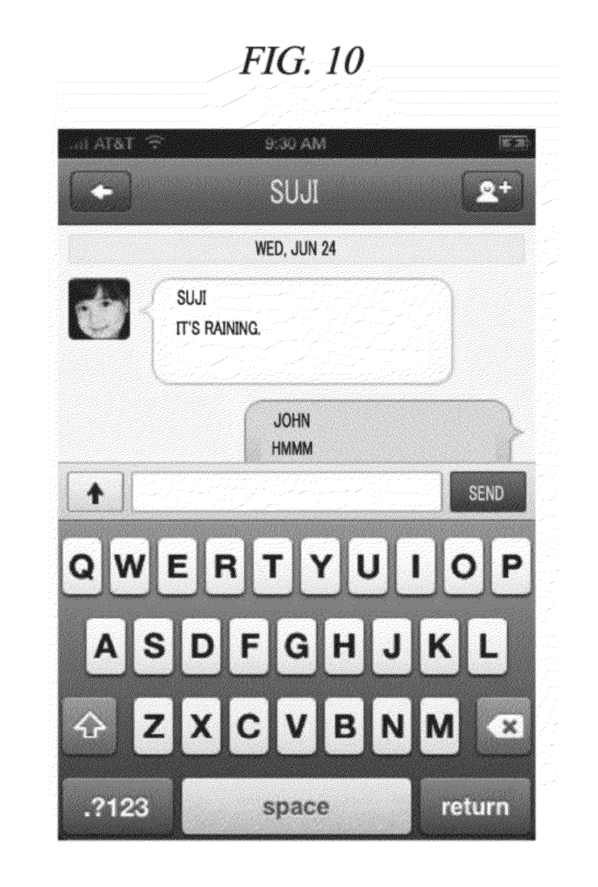

FIG. 10 is a reference view showing a screen displaying message exchange on a smart phone according to an exemplary embodiment.

As illustrated in FIG. 10, the user of the three screen devices exchanges a message with friends included in the integrated address book by using a common SMS or the like, and displays the message exchange in the form of chatting. The message exchange display method in the chatting form may be applied even to the case of chatting using the web service or the IPTV.

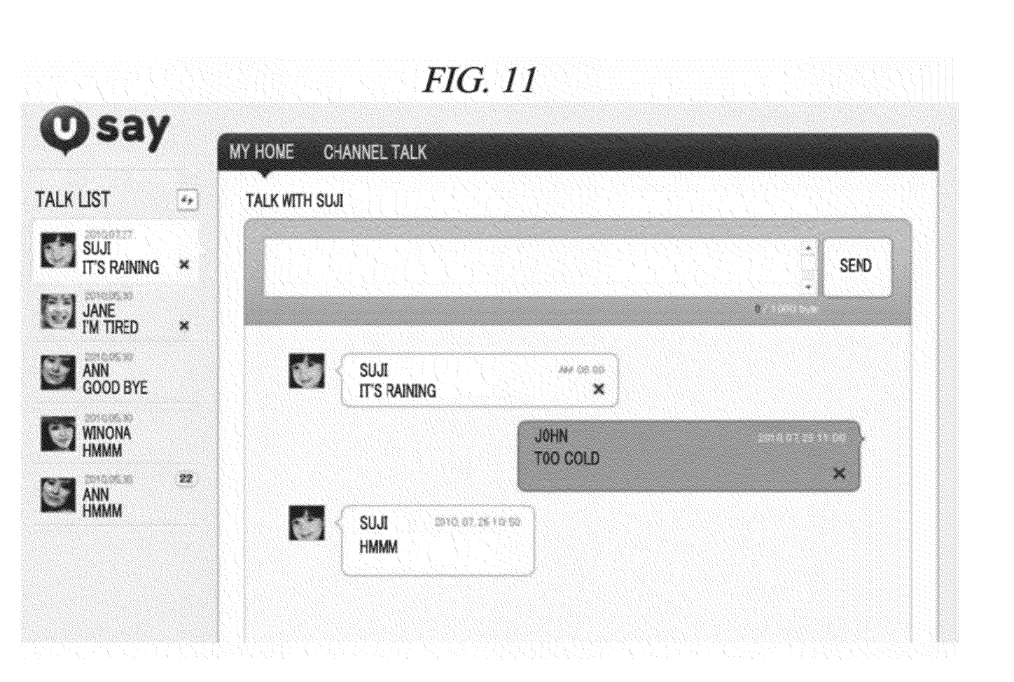

FIG. 11 is a reference view showing a screen displaying message exchange on a web page according to an exemplary embodiment.

As described, a message, which has been exchanged by using one of the three screen devices, is synthesized and displayed on the other screen devices. Accordingly, users can receive the social network service by using a preferred screen device through various networks.

The exemplary embodiments can be embodied in a storage medium including instruction codes executable by a computer or processor such as a program module executed by the computer or processor. A data structure in accordance with the exemplary embodiments can be stored in the storage medium executable by the computer or processor. A computer readable medium can be any usable medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The above description of the exemplary embodiments is provided for the purpose of illustration, and it would be understood by those skilled in the art that various changes and modifications may be made without changing technical conception and essential features of the exemplary embodiments. Thus, it is clear that the above-described exemplary embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the exemplary embodiments. It shall be understood that all modifications and embodiments conceived from the meaning and scope of the claims and their equivalents are included in the scope of the inventive concept.

What is claimed is:

1. A system for providing a social network service to multiple screen devices, the system comprising:
an integrated address book generating unit configured to generate an address book based on contact information stored in the multiple screen devices or contact information stored in a server;
a personal page providing unit configured to provide personal pages to the multiple screen devices;
a message managing unit configured to manage a message, which has been transmitted from one screen device of the multiple screen devices, so that the message is displayed on other screen devices of the multiple screen devices; and
a personal content managing unit configured to manage content, which has been uploaded from the one screen device of the multiple screen devices, so that the content is displayed on other screen devices of the multiple screen devices,
wherein the multiple screen devices includes an Internet Protocol Television (IPTV), and
the social network service is provided based on the address book.

2. The system of claim 1, further comprising:
a channel information managing unit configured to provide the multiple screen devices with real-time information on broadcast content for each channel and further configured to receive a review of each content from the multiple screen devices.

3. The system of claim 2, wherein the review of the content is overlaid on the content displayed on a screen of the IPTV.

4. The system of claim 2, further comprising:
an application providing unit configured to provide a first application which generates the address book in a smart phone included in the multiple screen devices.

5. The system of claim 4, wherein the application providing unit is further configured to provide a second application which provides the real-time information on broadcast content to the smart phone.

6. The system of claim 1, further comprising:
a data converting unit configured to convert data of the message or the content to a suitable resolution for each of the multiple screen devices.

7. A method for providing a channel talk service to multiple screen devices including an Internet Protocol Television (IPTV), the method comprising:
providing real-time information on broadcast content for each channel of the IPTV to the multiple screen devices;
receiving a message associated with the broadcast content from one of the multiple screen devices; and
transmitting the received message to the multiple screen devices,
wherein the received message is overlaid on the broadcast content displayed on a screen of the IPTV.

8. The method of claim 7, wherein the multiple screen devices include a smart phone, and the information on broadcast content is provided through an application of the smart phone.

9. The method of claim 7, wherein the IPTV activates a menu which displays the message in response to input from a remote controller of the IPTV.

10. A method for providing a social network service to multiple screen devices, the method comprising:
receiving data from one of the multiple screen devices;
converting the data into plural pieces of data suitable the multiple screen devices;
notifying the multiple screen devices of the receiving of the data; and
transmitting the converted plural pieces of data to the multiple screen devices,
wherein the multiple screen devices include an Internet Protocol Television (IPTV), and
when the IPTV is activated, the notifying of the receiving of the data is displayed on a screen of the IPTV.

11. The method of claim 10, further comprising:
generating an address book, which can be used by all the multiple screen devices,
wherein the notifying of the receiving of the data comprises a reference to the address book.

12. The method of claim 11, wherein the address book is generated based on contact information stored in the multiple screen devices or contact information stored in a server.

13. The method of claim 10, wherein the converted plural pieces of data comprises a message transmitted to one device of the multiple screen devices and content uploaded onto a personal page of a user of the multiple screen devices.

14. The method of claim 13, wherein the message is transmitted to one device of the multiple screen devices with reference to the address book.

15. The method of claim 13, wherein the one device of the multiple screen devices stored in the address book is notified of the receiving of the content.

16. The method of claim 10, further comprising:
providing the multiple screen devices with real-time information on broadcast content for each channel and receiving a review of broadcast content from the multiple screen devices.

17. The method of claim 16, wherein the review of the broadcast content is overlaid on the content displayed on a screen of the IPTV.

18. A non-transitory computer readable medium having instructions stored thereon which perform the method of claim 10.
